(19) United States
(12) Patent Application Publication
(10) Pub. No.: US 2009/0230239 A1
(43) Pub. Date: Sep. 17, 2009

(54) ICE PROTECTION POWER SUPPLY

(76) Inventor: Ian McGregor Stothers, Saham Toney (GB)

Correspondence Address: DICKSTEIN SHAPIRO LLP, 1825 EYE STREET NW, Washington, DC, 20006-5403, US

(21) Appl. No.: 12/293,394

(22) PCT Filed: Mar. 19, 2007
(86) PCT No.: PCT/GB2007/000964

§ 371 Date: Jan. 30, 2009

Related U.S. Application Data
(60) Provisional application No. 60/784,080, filed on Mar. 17, 2006.

(51) Int. Cl. B64D 15/12; B64D 41/00

(52) U.S. Cl. 244/58; 244/134 D

(57) ABSTRACT

There is disclosed an electrical system for an aircraft comprising: at least one generator (302); a power control system (304) for distributing power from the generator to electrical subsystems (306, 308) in the aircraft; and an ice protection control system (310) for controlling at least one ice protection device (312, 314, 316), wherein the ice protection control system is connected to said at least one generator.

The present invention relates to an electrical system, an ice protection control system, a method of installing an electrical system or an ice protection control system, and a method of controlling at least one ice protection device.

Conventionally, electrical components in an aircraft are powered via a power control system, which itself routes power from generators associated with one or more engines of the aircraft. This can allow centralised control of all power functions.

Ice protection systems (IPS) in aircraft are one such electrical component that draws power from the power control system (also known as the aircraft power panel). Ice protection systems protect against the build-up of ice on structures. One common application of ice protection systems is on aircraft. During flight, the surfaces of an aircraft can be exposed to water vapour at low temperatures and, if no preventative action is taken, ice can quickly form on the wings, on control surfaces, and on other parts of the aircraft in such a way as to alter the aerodynamic performance of the aircraft (for example by altering the airflow around the aircraft and by adding additional weight to it) with potentially catastrophic consequences.

Electrothermal ice protection systems typically comprise a number of electrically-powered heater elements such as heater mats, which can be used as anti-icing zones in which a sufficient temperature is maintained at the surface of the wing in order to prevent the formation of ice. These heater mats can also be used as de-icing zones to shed ice that has been allowed to accrete on the protected region. The de-icing mats are cyclically energised in order to melt the interface between the wing and the accreted ice, causing the ice to be shed.

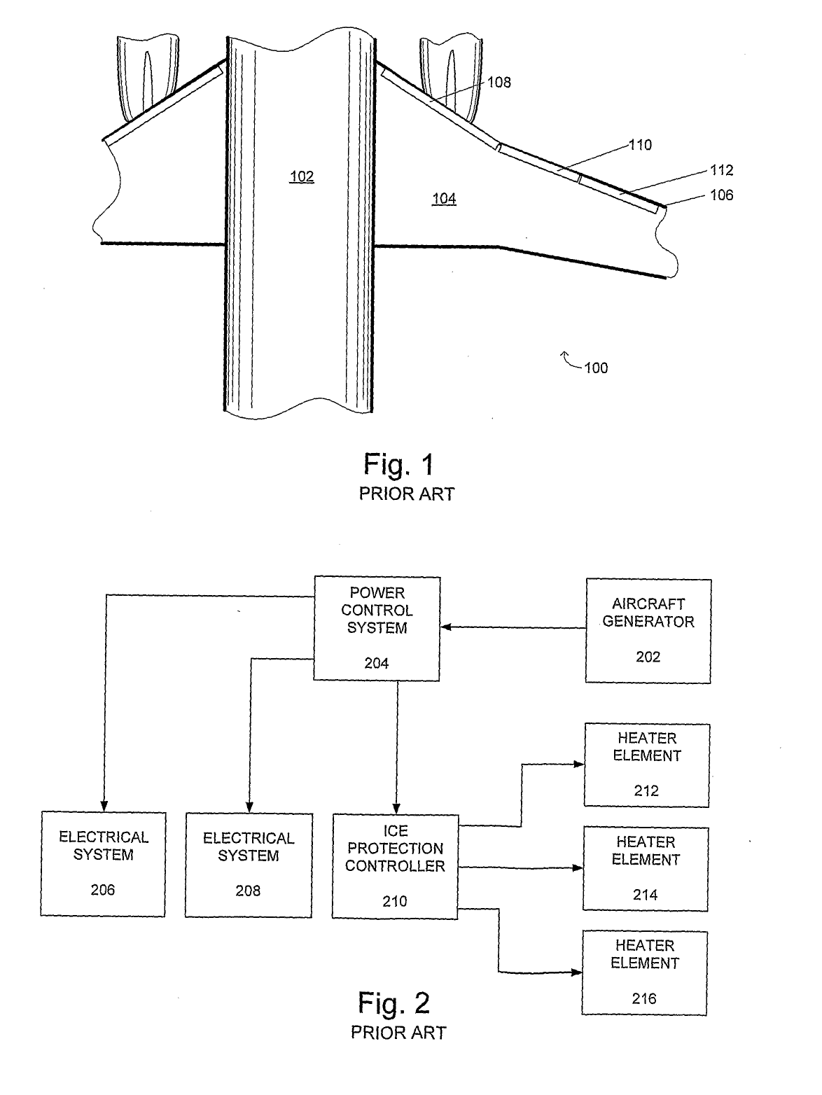

FIG. 1 is an illustration of a portion of an aircraft, showing the placement of heater zones in a conventional electrothermal aircraft ice protection system. The aircraft 100 includes a fuselage portion 102 and a wing portion 104. On the leading edge 106 of the wing 104, where ice accumulates most quickly, a plurality of heating mat zones 108, 110, 112 are provided. The heater mats may either be bonded to the outer or inner surface of the wing leading edge, or may be made an integral part of the structure.

FIG. 2 is a schematic of a power system that might be used in the aircraft of FIG. 1. An aircraft generator 202 (and possibly further generators) feeds power into the power control system (aircraft power panel) 204. The power control system 204 distributes power out to electrical systems 206, 208 in the aircraft, and also to the ice protection controller 210, which in turn switches power to heater elements 212, 214, 216 in the ice protection system. The power control system 204 also carries out other functions, such as generator load management and power usage monitoring. Conventionally it has been preferred to route all power through the power control system 204.

In view of issues arising in relation to conventional power control systems in aircraft, in a first aspect the present invention provides an electrical system for an aircraft comprising: at least one generator; a power control system for distributing power from the generator to electrical subsystems in the aircraft; and an ice protection control system for controlling at least one ice protection device, wherein the ice protection control system is connected (directly, that is not via the power control system) to said at least one generator.

It was found that such a system could provide a reduction in the amount of high power cabling required in an aircraft, resulting in a valuable weight saving. The system was found to be beneficial for ice protection systems in particular because of the relatively high power and relatively large number of switches that are required.

The ice protection system may further comprise at least one switch for controlling the supply of power to said at least one ice protection device, and a controller for controlling said at least one switch. The ice protection control system may further comprise a communications interface for transmitting power usage data to the power control system. This can allow the power control system to monitor and regulate all of the power consumption in the aircraft, including the power consumed by the ice protection system.

In an embodiment where the at least one generator is a plurality of generators, the ice protection control system may be operable to connect to each generator. This can provide a more reliable power supply.

The ice protection control system may be mounted adjacent to or proximate to (for example, within 0.5, 1, 2, 3 or 5 metres of) said at least one generator. In particular the ice protection control system may be attached to the wing of the aircraft. Additionally or alternatively, the power control system may be mounted adjacent to or proximate to (for example within 0.5, 1, 2, 3 or 5 metres of) said at least one generator, and may be attached to the wing of the aircraft.

The ice protection control system may also be powered by the power control system (for example low power components such as the control and switching functions may be powered separately by the power control system).

In another aspect of the invention there is provided an aircraft power system including at least one generator and a power control system, the aircraft power system being adapted to supply power to said at least one electrical component of the aircraft from at least one said generator, wherein the power is not supplied via the power control system.

In a further aspect of the invention there is provided an aircraft including at least one generator, a plurality of electrical components, an ice protection system, a power control system connected to said at least one generator, and an ice protection system controller also connected to said at least one generator, wherein the power control system supplies power to the plurality of electrical components and the ice protection system controller supplies power to the ice protection system. The ice protection system controller may be operable to transmit a signal to the power control system representative of the power consumption of the ice protection system (the controller and/or control system with this modification may also be provided in independent form). A plurality of generators may be provided, in which case the generator outputs may be interconnected.

In another aspect of the invention there is provided an aircraft including at least one generator having a respective at least one power output, a power control system connected to said at least one power output, and a plurality of electrical systems connected to the power control system, wherein the power control system is mounted in close proximity to (such as within 0.5, 1, 2, 3 or 5 metres of) at least one said generator. The power control system may be mounted on the wing of the aircraft.

In a further aspect of the invention there is provided a method of installing an electrical system for an aircraft, the method comprising: installing at least one generator; installing a power control system for distributing power from the generator to electrical subsystems in the aircraft; installing an ice protection control system for controlling at least one ice protection device; and connecting the ice protection control system to said at least one generator.

In a yet further aspect of the invention there is provided a method of installing an ice protection control system for an aircraft, the aircraft including at least one generator and a power control system for distributing power from the generator to electrical subsystems in the aircraft, and the method comprising attaching the ice protection control system to said at least one generator.

The ice protection elements may comprise heater mats and the like, magnetic force pulse elements as for example described in U.S. Pat. No. 4,895,322 (the content of which is hereby incorporated by reference), or electro impulsive elements (where a large electrical pulse is applied to the area) as for example described in U.S. Pat. No. 6,427,946 and U.S. Pat. No. 6,027,075 (the contents of which are hereby incorporated by reference), or any combination thereof, for example.

The present invention can be implemented in any convenient form, for example using dedicated hardware, or a mixture of dedicated hardware and software. The invention may further comprise a data network (for example to enable communications between the control system and other parts of the structure), which can include any local area network or other appropriate network. Aspects of the present invention encompass computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid-state memory device.

Although each aspect and various features of the present invention have been defined hereinabove independently, it will be appreciated that, where appropriate, each aspect can be used in any combination with any other aspect(s) or features of the invention. In particular, features disclosed in relation to apparatus aspects may be provided in appropriate form in relation to method aspects, and vice versa.

Embodiments of the present invention will now be described with reference to the accompanying drawings, in which:

FIG. 1 is an illustration of the placement of heater mats and heater zones of an ice protection system of an aircraft;

FIG. 2 is a schematic of a power system that might be used in the aircraft of FIG. 1.

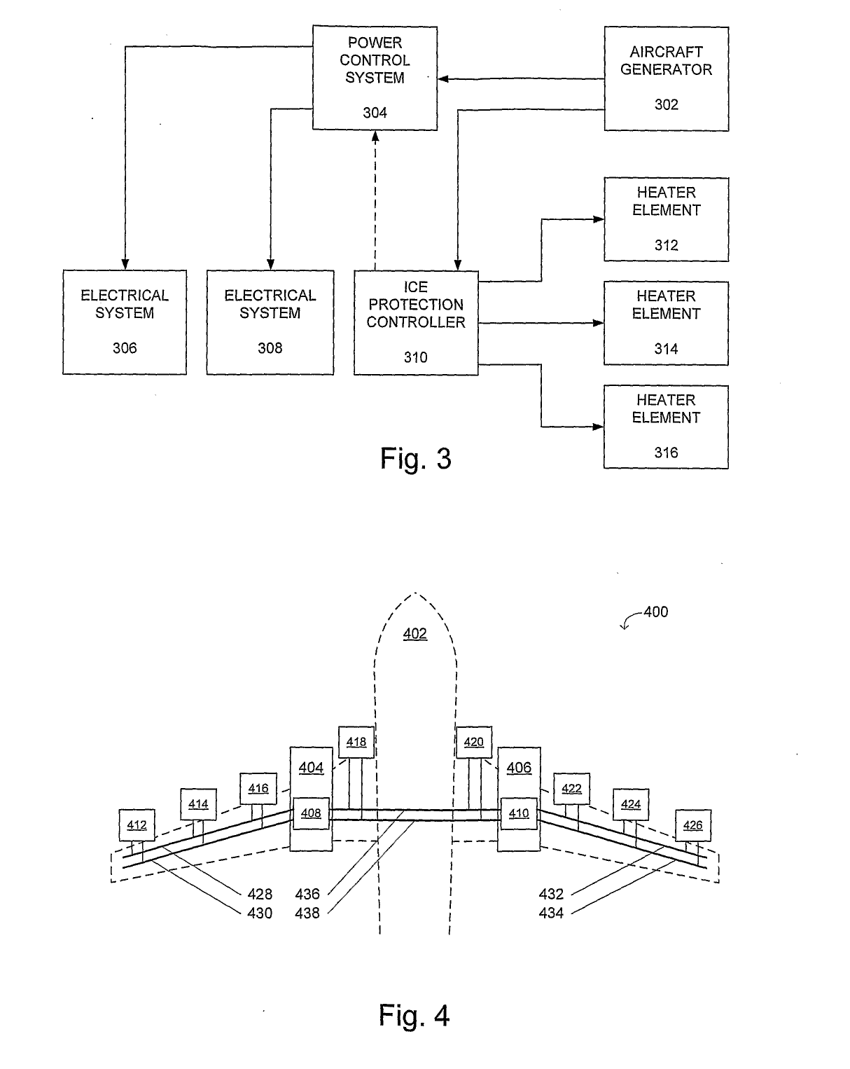

FIG. 3 is a schematic of an aircraft power system of a first embodiment; and

FIG. 4 is a schematic of an aircraft power system of a further embodiment.

A first embodiment of an aircraft electrical system for use with a single generator will be described. A further embodiment for use with two generators will then be described.

FIG. 3 is a schematic of an aircraft power system for use with single generator aircraft. An electrical generator 302 feeds power into the power control system 304, the aircraft power panel. The aircraft power panel distributes power to the aircraft electrical systems 306, 308 and also performs functions such as power load management, ground fault detection, current sensing and so on. The electrical systems 306, 308 may relate to various avionics functions, cabin lighting and air conditioning, and so on.

The ice protection controller 310 is one of the electrical systems on the aircraft, and is responsible for switching power to the heater elements 312, 314, 316 (such as heater mats, including de-icer strips and anti-icing parting zone heaters, for example) forming part of the electrothermal ice protection system (IPS). Normally considerably more heater elements would be provided, but these have been omitted for clarity. Additional ice protection controllers or subcontrollers may of course also be provided.

The ice protection controller 310 includes and controls switches that control the supply of power to a number of power buses (not shown) that carry power to each of the heater elements 312, 314, 316. The connection between each heater element 312, 314, 316 and the power buses can be switched independently by the controller 310.

The present embodiment employs switching of the IPS power supply in close proximity to the generator 302, and wiring to the generator rather than to the point of regulation for the generator at the power control system 304. This reduces the amount of wiring required and hence reduces cost and weight. This principle can be applied more generally to any aircraft electrical system, but is particularly suited to high power systems (where the cost and weight savings will be greatest due to the relatively thick and heavy cables which are needed).

In the present embodiment the generator provides three phase AC power, but the principles described herein are applicable to other types of power such as two phase AC power, DC power, and so on.

It will be appreciated that any number of further generators can be provided. A further embodiment in which two generators are provided will now be described with reference to FIG. 4.

FIG. 4 is a schematic of an aircraft power system of the further embodiment mentioned above.

The system includes the aircraft fuselage and wings 402, first and second engines 404, 406, first and second respective generator and switch units 408, 410, and a number of heater elements 412, 414, 416, 418, 420, 422, 424, 426 arranged along the wings. A first power bus, including a first power line 428 and a second power line 430 is connected to the first generator and switch unit 408, and a second power bus, including a third power line 432 and fourth power line 434, is likewise connected to the second generator and switch unit 410. A cross-link, including a fifth power line 436 and sixth power line 438, interconnects the two generator and switch units 408, 410.

Each of the heater elements 412, 414, 416, 418, 420, 422, 424, 426 taps into the appropriate power bus via a switch (not shown). The ice protection system controller (not shown) controls the operation of the system via the individual heater element switches and also the power bus switches in the generator and switch units 408, 410.

The cross-link is provided to maintain the safe operation of the IPS in the case of an engine or generator failure, such that each of the power buses can be supplied with power by more than one of the generators when required.

Other arrangements are of course possible. All switching may be carried out at the generator and switch units 408, 410, for example. Alternatively, all switching may be carried out at the heater elements 412, 414, 416, 418, 420, 422, 424, 426. Further systems for switching, for example to switch groups of heater elements rather than individual heater elements, are of course possible. The system can also be adapted to operate with power buses having a different number of power lines.

In more detail, in another exemplary embodiment, the aircraft includes primary and secondary power distribution units connected (ultimately) to the generator(s), and a separate IPS controller is provided in close proximity to the generator(s). The IPS controller performs the functions for the ice protection system that are normally undertaken by the aircraft power distribution unit (PDU, such as the power control system mentioned above). Such functions may include power load management, ground fault detection, current sensing and so on.

In this embodiment, the IPS controller provides a signal to the PDU reporting the amount of power being drawn from each generator by the IPS, to assist the PDU in managing the total power load on the aircraft.

The aircraft may alternatively be configured such that power is supplied via a (central or local) power controller (as in conventional systems), but where the power controller is mounted in close proximity to the generator(s), for example by mounting it on a wing instead of within the aircraft fuselage.

The switching for the ice protection system (or other high power or other electrical component) may be undertaken within, for example, 5, 4, 3, 2, 1 or less metres from the location of at least one generator, and may be carried out on the wing (instead of within the fuselage, for example).

The system described above can be used to provide an anti-icing and/or de-icing system for an aircraft but other applications may be possible. For example the system may be applied to other vehicles (including helicopters, cars, buses, trains, boats, space craft, and so on) or structures, and may be applied to other electrical systems in the aircraft or other vehicle.

Further modifications lying within the spirit and scope of the present invention will be apparent to a skilled person in the art.

1. An electrical system for an aircraft comprising:
at least one generator;
a power control system for distributing power from the generator to electrical subsystems in the aircraft; and
an ice protection control system for controlling at least one ice protection device, wherein the ice protection control system is connected to said at least one generator.

2. An electrical system according to claim 1, wherein the ice protection system further comprises at least one switch for controlling the supply of power to said at least one ice protection device, and a controller for controlling said at least one switch.

3. An electrical system according to claim 1, wherein the ice protection control system further comprises a communications interface for transmitting power usage data to the power control system.

4. An electrical system according to claim 1, where said at least one generator is a plurality of generators, and the ice protection control system is operable to connect to each generator.

5. An electrical system according to claim 1, wherein the ice protection control system is mounted adjacent to or proximate to said at least one generator.

6. An electrical system according to claim 1, wherein the ice protection control system is attached to the wing of the aircraft.

7. An electrical system according to claim 1, wherein the power control system is mounted adjacent to or proximate to said at least one generator.

8. An electrical system according to claim 1, wherein the power control system is attached to the wing of the aircraft.

9. An electrical system according to claim 1, wherein the ice protection control system is also powered by the power control system.

10. An aircraft power system including at least one generator and a power control system, the aircraft power system being adapted to supply power to said at least one electrical component of the aircraft from at least one said generator, wherein the power is not supplied via the power control system.

11. An aircraft including at least one generator, a plurality of electrical components, an ice protection system, a power control system connected to said at least one generator, and an ice protection system controller also connected to said at least one generator, wherein the power control system supplies power to the plurality of electrical components and the ice protection system controller supplies power to the ice protection system.

12. An aircraft according to claim 11, wherein the ice protection system controller is operable to transmit a signal to the power control system representative of the power consumption of the ice protection system.

13. An aircraft according to claim 11, wherein a plurality of generators is provided, and the generator outputs are interconnected.

14. An aircraft including at least one generator having a respective at least one power output, a power control system connected to said at least one power output, and a plurality of electrical systems connected to the power control system, wherein the power control system is mounted in close proximity to at least one said generator.

15. An aircraft according to claim 14, wherein the power control system is mounted on the wing of the aircraft.

16. A method of installing an electrical system for an aircraft, the method comprising:
installing at least one generator;
installing a power control system for distributing power from the generator to electrical subsystems in the aircraft;
installing an ice protection control system for controlling at least one ice protection device; and
connecting the ice protection control system to said at least one generator.

17. A method of installing an ice protection control system for an aircraft, the aircraft including at least one generator and a power control system for distributing power from the generator to electrical subsystems in the aircraft, and the method comprising attaching the ice protection control system to said at least one generator.
